(19) United States
(12) Patent Application Publication
(10) Pub. No.: US 2005/0054399 A1
(43) Pub. Date: Mar. 10, 2005

(54) Method and apparatus for providing improved antenna bandwidth

(76) Inventor: Nicholas E. Buris, Deer Park, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/659,677

(22) Filed: Sep. 10, 2003

(51) Int. Cl. H04Q 7/20

(52) U.S. Cl. 455/575.7; 455/575.1

(57) ABSTRACT

A radio communication device (100) includes a metallized housing and an antenna (106). The metallized housing includes an antenna bandwidth enhancement slot (108) that causes multiple electrical paths to be generated for the dense surface currents found on the metallized housing. Hence, multiple resonances are introduced to the antenna (106). A method for increasing the antenna bandwidth for a radio communication device that utilizes a metallized conductive housing is also described.

### TECHNICAL FIELD

This invention relates in general to the field of radio communications and more specifically to a method and apparatus for providing improved antenna bandwidth.

### BACKGROUND

In recent years, due to styling and other marketing considerations, radio communication devices such as cellular telephones with metallized housing have started to appear in the marketplace. Typically, these cellular telephones are equipped with internal antennas, or external retractable antennas. When a fixed external antenna (sometimes referred to as a “stubby”) is used with a cellular telephone that has a metallized housing, antenna operation suffers from narrow or reduced impedance bandwidth. This is a major problem in today's marketplace, where cellular telephone antennas need to have broad bandwidths given the multiple air interfaces that they are typically required to operate in. The majority of multi-band cellular telephones operate using air interfaces near 900 Mega Hertz (MHz) (e.g., GSM, NADC, US-CDMA) and 1850 MHz (e.g., DCS, PCS). This leads to a dual-resonant consideration with broad resonances at both the lower and higher frequencies to account for the multiple operating frequency bands. The helix and whip antenna configuration with switched impedance networks is well suited to provide such dual-band performance. However, in the presence of a metal or metallized housing, the bandwidth at both resonances may not be sufficient to handle the multiple air interfaces.

Metallized housings for “flip-phones” (cellular telephones having a foldable section) have been receiving attention both as a customer preference due to their small sizes, as well as an effective means to increase radiation efficiency. So it seems the trend in the marketplace is for more radio telephones having conductive metallized housings. Given the problems mentioned above, a need exists in the marketplace for a method and apparatus that can help improve the antenna impedance bandwidth of radios utilizing metallized housings.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows an illustration of a radio telephone in accordance with an embodiment of the invention.

FIG. 2 shows an illustration of the slot used in the radio telephone shown in FIG. 1.

FIG. 3 shows a graph highlighting measured return loss versus frequency for different slot heights for the slot used in the radio telephone shown in FIG. 1.

FIG. 4 shows an illustration of a radio telephone in accordance with another embodiment of the invention.

FIG. 5 shows an illustration of the slot used in the radio telephone shown in FIG. 4.

FIG. 6 shows a graph highlighting measured return loss versus frequency for different slot extension lengths for the slot used in the radio telephone shown in FIG. 4.

FIG. 7 shows an illustration of a radio telephone having an L-like slot in accordance with another embodiment of the invention.

FIG. 8 shows an illustration of the slot used in the radio telephone shown in FIG. 7.

FIG. 9 shows a graph highlighting measured return loss versus frequency for different “h2” slot heights for the slot used in the radio telephone shown in FIG. 7.

FIG. 10 shows a graph highlighting return loss versus frequency for a radio having an “L” slot and a flip.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

The reason that some cellular telephones having grounded metallized housings and that use fixed external antenna exhibit narrow bandwidths is that they excite strong currents in their conductive metal housings. These currents flow through the housing and distribute themselves in such a way that the housing acts almost as a dipole antenna.

In accordance with an embodiment of the present invention, a slot in the housing is provided that forces the current distribution in the metallized housing to follow different paths, or different lengths. The differences in length of the current distribution caused by the slot in the metal housing of the radio results in broader bandwidth operation for the radio.

Referring now to FIG. 1, there is shown a cellular telephone such as a “flip-phone” having a metallized housing comprising a first section 102 and a flip section 104. The metallized housing can be a housing made of metal or a non-metal housing that has been coated with a conductive metallized material, etc. The flip section 104 of the housing can be placed in a closed or open position. When in the open position, the flip section 104 extends the overall length of the metallized radio housing formed by sections 102 and 104. An antenna or antenna assembly 106 is electrically coupled to the metallized housing with the metallized housing acting as a ground plane for the antenna. In accordance with one embodiment of the invention, the flip section 104 includes an “L” slot 108 that is cut into the flip section 104 of the radio telephone 100.

The large density of surface currents that occur on the metallized (conductive) housing, forces the consideration of the housing as an integral portion of the antenna assembly. By cutting a slot(s) into the flip section 104, multiple electrical paths can be created for the surface currents to follow; hence multiple resonances can be introduced.

For the invention, a fully parameterized model of a flip-phone was developed for simulation study using electromagnetic solver software. The radio model used for the study comprised a metal housing and an antenna assembly. The metal housing utilized a flip section that opened and closed to various degrees. The antenna assembly used in the simulations comprised a conventional helix and whip combination, surrounded by a material over mold, and was driven against the grounded metal housing. The helix was tuned to resonate at 850 MHz while the whip generated a broad resonance at 2.2 Giga-Hertz (GHz), benefiting from the second harmonic resonance of the helix. Note that although a helix/whip antenna assembly has been described here, the performance of other antenna assemblies will also benefit from the use of a slot in accordance with the invention.

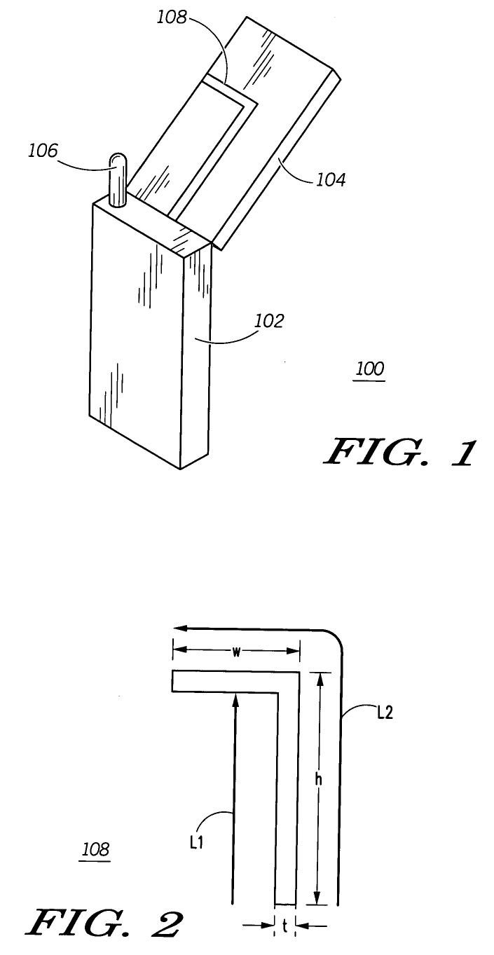

In FIG. 2, there is shown a diagram of slot 108. Slot 108 has a height “h”, a short arm length “w” and a slot width “t”. The initial modeling effort to determine the potential antenna bandwidth improvement by means of cutting slots into the phone flip section 104 incorporated an inverted “L” shaped slot 108. This slot geometry provides two electrical paths for the surface currents on the flip to follow, as indicated by L1 and L2 in FIG. 2.

The parameters L1 and L2 provide resonances at frequencies f1 and f2. L2, being the longer path, is chosen to contribute to the low band resonance and likewise, L1, being the shorter current path, contributes to the high band resonance. As L1 is reduced, L2, which is dependent on L1, also is reduced and as a result f1 and f2 grow proportionally larger.

A simplified model of a flip-phone was made to include a parameterized 90-degree cut-out (L-shaped slot) 108 from the metal flip 104. A design-of-experiments (DOE) was constructed for a parameter sweep simulation using the electromagnetic solver software. The slot was specified as having 3 mm in thickness, t, and had short arm length, w, and long arm length, h, chosen as swept parameters. First, the parameter h was varied from 30 mm to 70 mm while w was held constant at 25 mm.

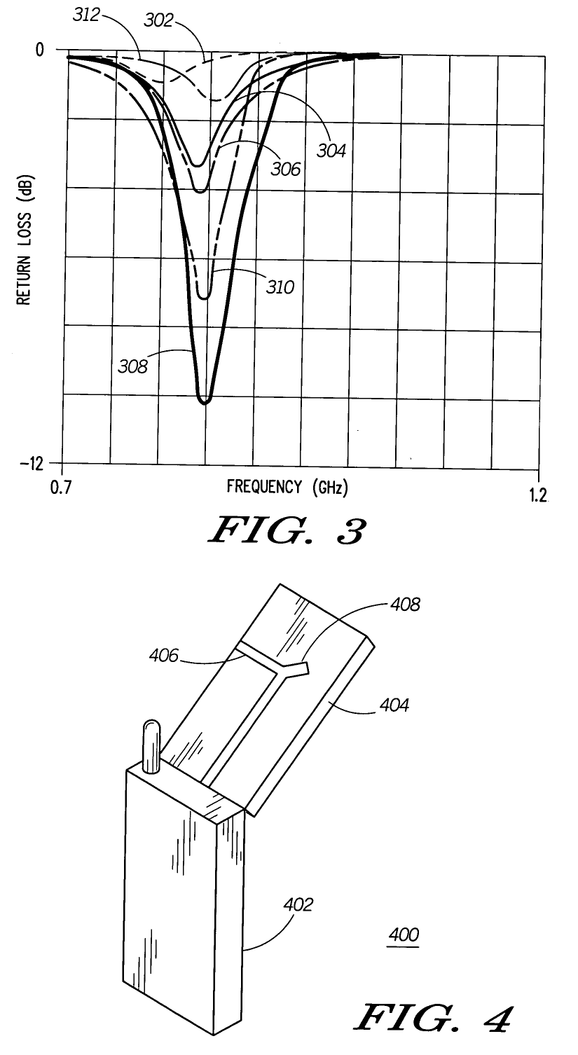

In FIG. 3, an overlay of the return loss profiles for the various cases (50Ω source impedance is used) is illustrated. As experimental data indicates that the bandwidth challenge is predominantly near the 900 MHz band for flip phones, the focus of the simulations conducted were near this frequency range.

In the case where no slot (e.g., L-shaped slot 108) is provided on the metallized housing, shown by graph line 302, a nominal resonance of 1 dB is found at 800 MHz. As the long arm length, h is increased from 30 mm to 50 mm the resonance moves to 850 MHz and dips to 11 dB at the resonance. Graph line 304 highlights the result using a slot height, h, of 30 mm, graph line 306 shows the result with h set at 40 mm and graph line 308 shows the result with h set at 50 mm. As, h, is increased from 50 mm to 70 mm, L1 and L2 begin to more closely resemble the electrical length of the flip without the slot and, as expected, the return loss profile begins to more closely resemble the nominal, no-slot case. Graph line 310 shows the results when h is set at 60 mm, and finally, graph line 312 shows the results for h set at 70 mm.

A parameter sweep was also run on the right-angle slot varying both the width and the height of the “L” shaped slot. A 25 millimeter (mm) width and 50 mm height was determined to be an optimal geometry with the given antenna location and a slot width of 3 mm. With the optimal slot included, the return loss profile demonstrates approximately a −11 dB resonance at 850 MHz. These initial results indicate an appreciable bandwidth improvement when using a right angle slot to create dual current paths on the flip as compared to using no slot on the radio housing.

Referring now to FIG. 4, there is shown another embodiment of the invention wherein a radio 400 includes a first section 402 and a flip section 404 having an L-shaped slot 406 that includes a diagonal slot extension 408. An additional series of experiments was conducted to determine whether the slot extension 408 located at the knee (at the intersection of the short and long arm) of the L shaped slot 406 might allow independent tuning of one resonance by altering its corresponding path length independently of the other.

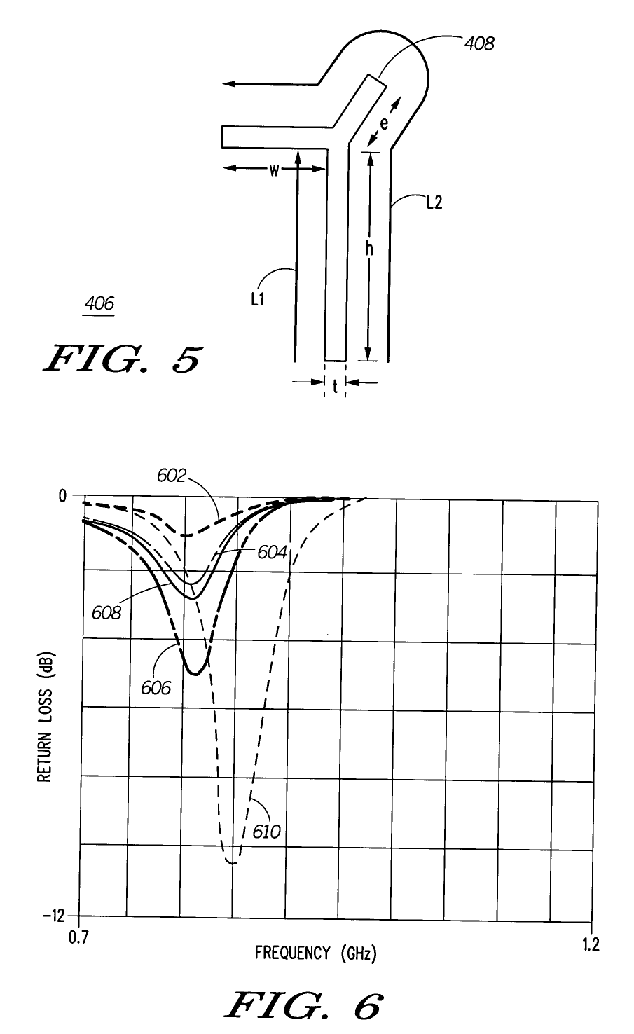

In FIG. 5, there is shown a drawing of the slot 406 having extension 408. The slot extension 408 has a length “e”; the slot 406 has a width “t”, a long-arm length “h” and a short-arm length “w”. As the slot extension 408 is increased, current path L2 is lengthened, moving the low band resonance down, while the L1 current path remains the same as the slot 108. The dimensions for the L shaped slot were chosen based on the use of optimization exercises. As the slot extension length, e, was increased from 7.5 mm to 20.5 mm, the resonance was tuned from 850 MHz to 810 MHz as shown in FIG. 6. The small degree of frequency shift in response to the change in extension length, e, may be explained by realizing that the associated path length was located opposite to the antenna location and as a result, observed a lower surface current density. Additionally, the path length increase due to the length of the extension 408 is a smaller percentage of the total length when the metallization of the housing is considered along with the flip.

In FIG. 6, there is shown a graph highlighting measured return loss versus frequency for different slot extension lengths, e, for the slot used in the radio telephone shown in FIG. 4. Graph line 602 shows the results for the no slot used situation, graph line 604 shows the results for an extension length e of 7.5 mm, graph line 606 shows the results for an extension length of 10.5 mm, graph line 608 shows the results for an extension length of 20.5 mm and finally, graph line 610 shows the results for an L shaped slot without an extension (e=0 mm).

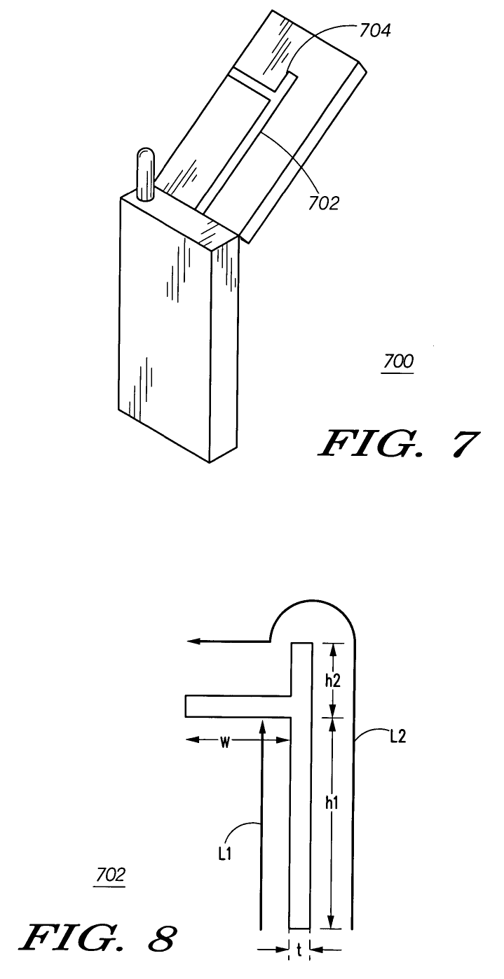

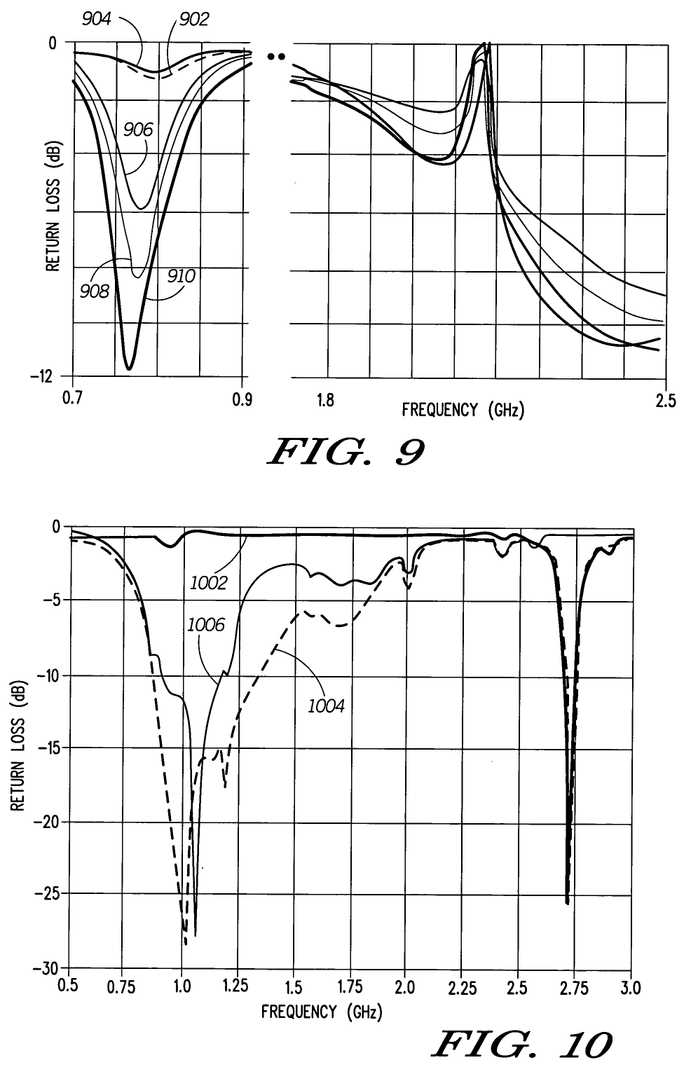

A third set of simulations was performed using a different slot extension as shown in FIG. 7. Shown in FIG. 7, is a flip-phone having a metallized housing which includes a slot 702 having a slot extension 704. The short arm of the slot is positioned at various heights along the long arm of the “L-like shaped” slot 702. As slot height h1, is decreased in length, the current path sees a shorter length in L1 and a somewhat longer length in L2 as shown in FIG. 8. This causes the high band resonance to be pushed up and the low band resonance to be pushed down as shown in FIG. 9, thereby providing for dual tuning.

In FIG. 9, the effects of using different slot heights, “h1” in slot 702, is highlighted. The slot height, “h2” increases in length as “h1” is decreased, this causing the short arm of the “L” shaped member (horizontal arm as shown in FIG. 8) to move up and down along the long arm (vertical long arm). Graph line 902 shows the results of using no slot 702 on radio 700. Graph line 904 highlights the results for a slot height, h1, of 50 mm, graph line 906 highlights the results when using a slot height, h1, of 40 mm. Graph line 908 shows the results when using a slot height, h1, of 30 mm and finally, graph line 910 shows the results when using a slot height, h1, of 20 mm (h2=20 mm).

Validation of the previously discussed simulation results was performed using a prototype flip phone having a metallized housing. A contra-wound, common fed, dual-helical antenna was utilized for the measurements and all measurements were taken using 50 ohm source impedance. With the metal flip in the closed position, the antenna operates with a broad bandwidth of 40% at 1 GHz as shown by graph line 1004 shown in FIG. 10. With the metal flip in the open position, and no slot present, the resonance is dramatically reduced as shown by the graph line 1002. With the metal flip in the open position, and the optimal inverted “L-like” slot present (similar to flip phone 100) the resonance reappears with an appreciable bandwidth of 21% at 1.1 GHz as shown by graph line 1006. A 25 mm width and 5 mm height was determined to be an optimal geometry with the given antenna location and a slot width of 3 mm.

The results of the simulations and prototyping indicate that presenting a slot to a metal flip may provide the necessary bandwidth enhancement to a deficient antenna. As the large density of surface currents present on the metal flip requires acceptance of the housing as a significant portion of the antenna assembly, it is only appropriate to include the mechanical and industrial design of the housing as part of the antenna engineering process.

Although only a limited number of slot geometries were discussed, it is clear that numerous unique geometries may be pursued as a means to find a clear compromise between antenna performance and industrial design integrity depending on a particular radio design. For example, slots having “J” shapes, “T” shapes, etc. can also be used. Also, although flip phones were discussed, those of ordinary skill in the art will appreciate that other radio communication device housing designs can also benefit from the bandwidth enhancing benefits of the present invention. The invention is also not limited to cellular telephones but can be used with non-cellular radio communication devices and at other frequencies than those discussed above.

While the preferred embodiments of the invention have been illustrated and described, it will be clear that the invention is not so limited. Numerous modifications, changes, variations, substitutions and equivalents will occur to those skilled in the art without departing from the present invention as defined by the appended claims.

1. A radio communication device, comprising:
a metallized housing;
an antenna coupled to the metallized housing; and
the metallized housing includes a antenna bandwidth enhancing slot that at least increases the bandwidth of the antenna.

2. A radio communication device as defined in claim 1, wherein the metallized housing includes a flip section that can be placed in an open or closed position.

3. A radio communication device as defined in claim 2, wherein the antenna bandwidth enhancing slot is located on the flip section.

4. A radio communication device as defined in claim 1, wherein the antenna bandwidth enhancing slot comprises a substantially “L” shaped slot.

5. A radio communication device as defined in claim 4, wherein the “L” shaped slot includes a slot extension.

6. A radio communication device as defined in claim 1, wherein the antenna bandwidth enhancing slot causes surface currents located on the metallized housing to take multiple paths and thereby introduce multiple resonances.

7. A radio communication device as defined in claim 6, wherein the antenna comprises a helical and whip combination.

8. A radio communication device as defined in 6, wherein the antenna is electrically coupled to the metallized housing which is grounded.

9. A radio communication device as defined in 1, wherein the radio communication device comprises a cellular telephone.

10. A method for increasing the antenna bandwidth of an antenna found in a radio communication device, comprising the steps of:
providing a metallized housing for the radio communication device; and
placing a slot on the metallized housing in order to cause electrical currents flowing in the metallized housing to take different paths in order to at least increase the bandwidth of the antenna.

11. A method as defined in claim 10, wherein the slot placed on the metallized housing comprises a substantially “L” shaped slot.

12. A method as defined in claim 11, wherein the “L” shaped slot includes a slot extension.

13. A method as defined in claim 10, wherein the radio communication device comprises a cellular telephone and the metallized housing includes a flip section that can move between an open position and a closed position.

14. A method as defined in claim 13, wherein the slot is located on the flip section.

15. A method as defined in claim 14, wherein a portion of the antenna is located external to the metallized housing.

16. A cellular telephone, comprising:
an antenna;
a metallized housing coupled to the antenna and having a movable section that can be placed in an open or closed position; and
a slot located on the movable section, the slot causing any surface currents found on the metallized housing during operation of the antenna to take multiple electrical paths.

17. A cellular telephone as defined in claim 16, wherein the slot at least increases the bandwidth of the antenna.

18. A cellular telephone as defined in claim 17, wherein the slot comprises a substantially “L” shaped slot.

19. A cellular telephone as defined in claim 16, wherein the slot allows for at least two electrical paths for the surface currents to take.

20. A cellular telephone as defined in claim 18, wherein the “L” shaped slot has a short arm and a long arm and the short arm is located along the long arm's length in such a location along the length of the long arm that dual tuning of the antenna bandwidth can be achieved.

21. A radio communication device, comprising:
a electrically conductive housing;
an antenna coupled to the conductive housing; and
the conductive housing includes a slot that enhances the bandwidth of the antenna.

22. A radio communication device as defined in claim 21, wherein the slot causes electrical currents that are generated when the antenna is transmitting electrical signals to follow different paths having different lengths.

23. A radio communication device as defined in claim 22, wherein the different lengths the electrical currents have to take results in broader bandwidth for the antenna.
